(19) United States
(12) Patent Application Publication
(10) Pub. No.: US 2008/0118670 A1
(43) Pub. Date: May 22, 2008

(54) Automatic Connecting Structure for a Shell Structure

(76) Inventor: Ching-Long ONG, Shengang Township (TW)

Correspondence Address: Dr. BANGER SHIA, 102 Lindencrest Ct., Sugar Land, TX, 77479-5201, US

(21) Appl. No.: 11/874,378

(22) Filed: Oct. 18, 2007

(30) Foreign Application Priority Data
Nov. 17, 2006 (TW) 095220369

(51) Int. Cl. B31D 99/00

(52) U.S. Cl. 428/12

(57) ABSTRACT

An automatic connecting structure for a shell structure in accordance with the present invention, the shell structure comprises: a main shell on which being disposed a composite member, and connecting members located between the main shell and the composite member for connecting them together. The connecting members can be adhesive members or convex and concave engaging structures. The main shell is pre-set in the mold for molding the composite member, the connecting structure is automatically formed after molding of the composite member.

### BACKGROUND OF THE INVENTION

1. Field of the Invention

The present invention relates to an automatic connecting structure for a shell structure, and more particularly to a connecting structure capable of connecting decorative structure or other neighboring components to a main shell quickly and stably.

2. Description of the Prior Art

Currently, there are many methods for connecting structures, such as: gluing, welding, or even screwing. Nowadays, composite material is popular, and the technique of integrally forming respective materials by prepreg of resin is also very mature. However, the connecting of the respective materials requires a medium layer, and then the materials can be effectively bonded together. Therefore, a method was proposed, which comprises the steps of:

providing a structural layer;

laminating the structural layer with a first resin or disposing the first resin beneath the structural layer;

curing the structural layer and the first resin into an integral body;

putting the structural layer into a mold;

softening the structural layer and the first resin by hot pressing, and then removing the surplus portion;

heating the structural layer and the first resin of the removed surplus portion by heat resource;

putting the softened structural layer and first resin back into the mold;

disposing another injection molding mold into the mold and injecting a melted second resin into the mold;

combining the second resin and the structural layer into an integral body by cooling them down.

As far as this method is concerned, the structural layer and the first resin must be heated repeatedly and their molds must also be exchanged, which increases the labor cost and the production cost. In addition, the lamination of the resin onto the structural layer involves a hot melting process which is quite complicated.

The present invention has arisen to mitigate and/or obviate the afore-described disadvantages.

### SUMMARY OF THE INVENTION

The primary objective of the present invention is to provide an automatic connecting structure for a shell structure capable of solving the abovementioned problems.

An automatic connecting structure for a shell structure in accordance with the present invention, the shell structure comprises: a main shell on which being disposed a composite member, and connecting members located between the main shell and the composite member for connecting them together. The connecting members on the main shell are preformed, and the composite member is formed after molding of the main shell and is integrally formed with connecting members opposite the connecting members of the main shell for connecting the composite member to the main shell quickly and stably.

### BRIEF DESCRIPTION OF THE DRAWINGS

FIG. 1 is an exploded view of an automatic connecting structure for a shell structure in accordance with the present invention;

FIG. 2 is another exploded view of the automatic connecting structure for a shell structure in accordance with the present invention;

FIG. 3 is a perspective view of the automatic connecting structure for a shell structure in accordance with the present invention;

FIG. 4 is a perspective view of a main shell structure of the shell structure in accordance with the present invention;

FIG. 5 is a cross sectional view of showing the molding of the automatic connecting structure for a shell structure in accordance with the present invention;

FIG. 6 is a block diagram showing the molding processes for forming the automatic connecting structure for a shell structure in accordance with the present invention; and

FIG. 7 is another cross sectional view of showing the molding of the automatic connecting structure for a shell structure in accordance with another embodiment of the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

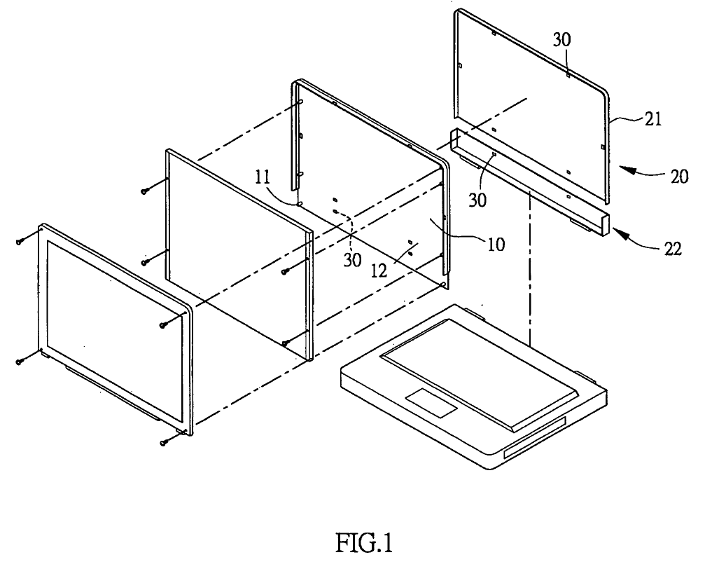

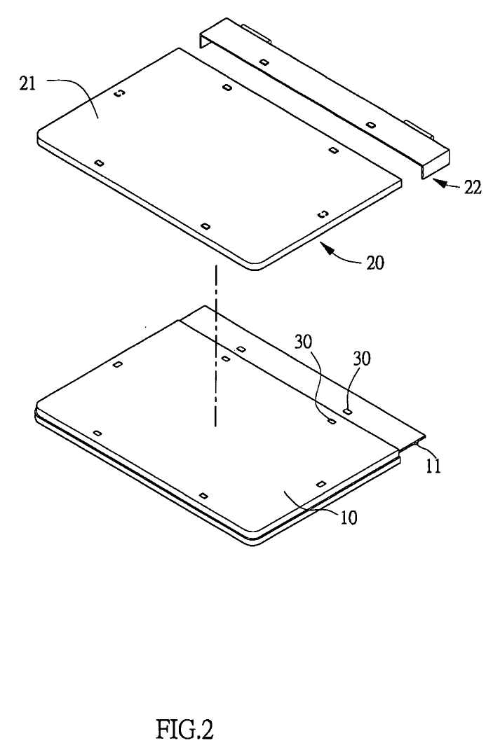

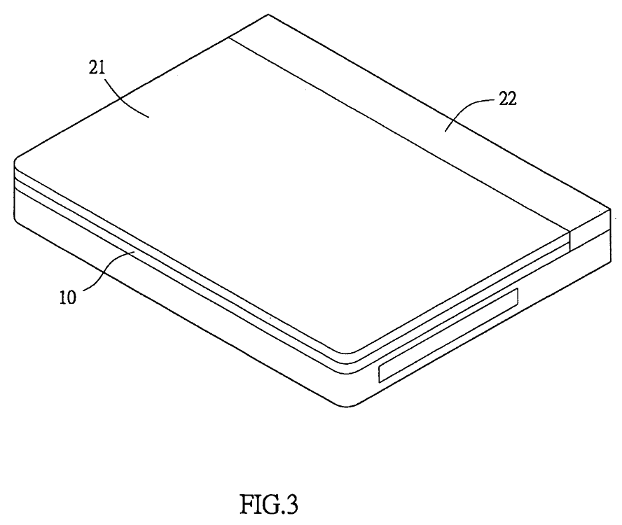

Referring to FIGS. 1-3, a shell structure in accordance with the present invention comprises: a main shell 10 on which being disposed a composite member 20, and connecting members 30 located between the main shell 10 and the composite member 20 for connecting them together.

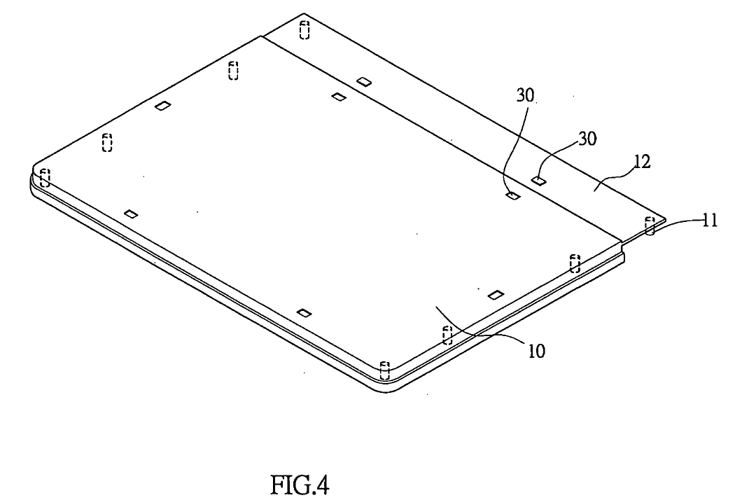

The main shell 10 is a main part of the shell structure and includes structures for connecting to other components, as shown in FIG. 4, which can be the mounting structure for mounting screen or other connecting structures. For example, the main shell 10 can be provided with pins 11 for connecting screw bolts, connecting portion 12 for connecting to the composite member 20, and the connecting members 30 for connecting to the composite member 20.

The composite member 20 includes the decorating sheet 21 or the connecting member 22 on the main shell 10.

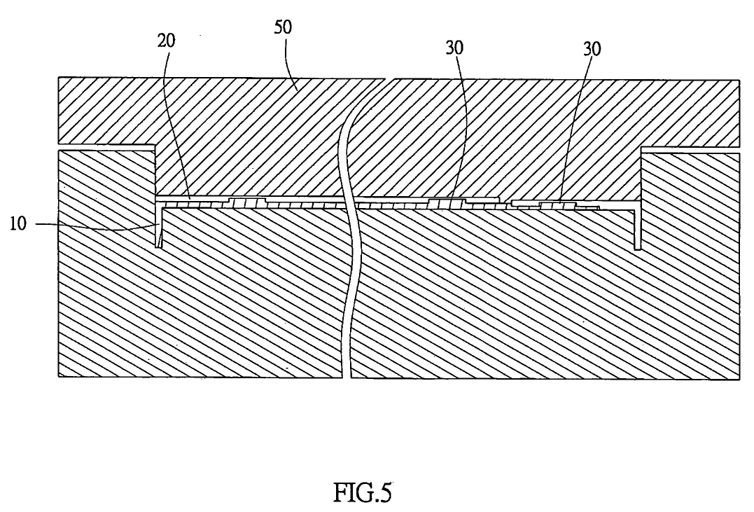

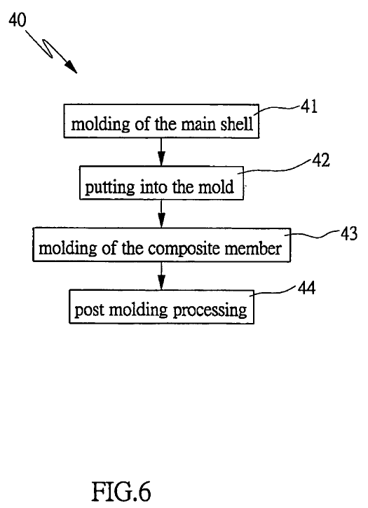

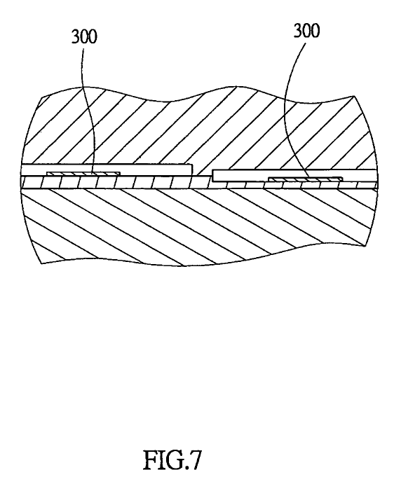

A method 40 for connecting the main shell 10 and the composite member 20, with reference to FIGS. 5-7, comprises:

step 43: forming various connecting structures on the main shell 10, including the forming of the connecting members 30 for connecting the composite member 20;

step 42: putting the formed main shell 10 into a female mold 50;

step 43: while forming the composite member 20 into the female mold, connecting members 30 being formed on the composite member 20 opposite the connecting members 30 of the main shell 10 for purpose of bonding, meanwhile, the composite member 20 being formed in the shape of the mold 50;

step 44: after connecting the connecting members 30 together, the composite member 20 is also integrated.

The step 43 can be carried out in various formats, including: extrusion molding, injection molding, transfer molding, die casting, and etc, by way of BMC (bulk molding compound) or SMC (sheet molding compound). The composite material 20 can be thermoplastic or thermoset material or can be metallic material. When extrusion molding, injection molding, transfer molding or pouring molding is used, the composite member 20 can be made of plastic or carbon fiber. Or if die casting is used, the material of the composite member 20 can be a kind of metal.

As it is aforementioned, the connecting members 30 can be integrally formed during the molding of the main shell 10, or they can be bonded to the surface of the main shell 10 initially by an adhesive member 300 after molding of the main shell 10, and then are integrally formed with the composite member 20.

While we have shown and described various embodiments in accordance with the present invention, it is clear to those skilled in the art that further embodiments may be made without departing from the scope of the present invention.

What is claimed is:

1. An automatic connecting structure for a shell structure, the shell structure comprising: a main shell on which being disposed a composite member, and connecting members located between the main shell and the composite member for connecting them together;
wherein the main shell is a main part of the shell structure and includes structures for connecting to other components, the main shell is provided with connecting members for connecting to the composite member;
the composite member is a decorating sheet or a connecting member on the main shell;
the composite member is formed after putting the preformed main shell into a mold, the composite members is integrally formed with connecting members opposite the connecting members of the main shell.

2. The automatic connecting structure for a shell structure as claimed in claim 1, wherein the composite member is made of one of the following materials: thermoplastic, thermoset or metal.

3. The automatic connecting structure for a shell structure as claimed in claim 1, wherein the connecting members are integrally formed during molding of the main shell.

4. The automatic connecting structure for a shell structure as claimed in claim 1, wherein the connecting members are bonded to a surface of the main shell initially by an adhesive member after molding of the main shell, and then are integrally formed with the composite member.
